(19) United States
(12) Patent Application Publication
(10) Pub. No.: US 2016/0280519 A1
(43) Pub. Date: Sep. 29, 2016

(54) Tire Lift Cable Guide Assembly

(71) Applicant: Bridgestone Bandag, LLC, Muscatine, IA (US)

(72) Inventor: Matthew J. Abraham, Illinois City, IL (US)

(21) Appl. No.: 15/079,402

(22) Filed: Mar. 24, 2016

Related U.S. Application Data
(60) Provisional application No. 62/139,222, filed on Mar. 27, 2015.

(51) Int. Cl. B66F 3/24; B66F 3/25

(52) U.S. Cl. CPC B66F 3/242; B66F 3/25

(57) ABSTRACT

Implementations described herein relate to guide assemblies for a tire lift assembly. The guide assembly includes a mounting plate, a support structure extending from the mounting plate, and rollers. The mounting plate includes mounting holes to connect the mounting plate to a casting of the tire lift assembly. The support structure includes a first wall, a second wall, and a third wall that define an opening. The first wall is connected to and extending from the mounting plate, and the second wall and the third wall are connected to and extending from the first wall. The second wall may be opposite the third wall. The rollers are rotatably supported by the second wall and the third wall with each roller positioned on opposing sides of the opening. Each roller rotates relative to the support structure when a cable of the tire lift assembly travelling through the opening contacts the roller.

### CROSS-REFERENCE TO RELATED PATENT APPLICATIONS

The present application claims the benefit of U.S. Provisional Patent Application No. 62/139,222, filed Mar. 27, 2015, and entitled “TIRE LIFT CABLE GUIDE ASSEMBLY”, the entirety of which is incorporated herein.

### FIELD OF THE DISCLOSURE

The present disclosure relates to tire lifts and, more particularly, to tire lifts for use in tire retreading operations.

### BACKGROUND

Various types and arrangements for tire lifts are known. Certain specialized applications, such as tire retread operations, use specialized lifts that are used to move tires and tire carcasses along an assembly line, and to also help mount and dismount those tires from various machines and equipment disposed along the assembly line. Cables having hooks connected at their ends are sometimes used to engage tires or carcasses by their beads so they can be lifted and transported to and from tire equipment. The sometimes unique sequences of motion used in retreading operations, which include lifting or lowering the tire while simultaneously laterally moving the tire in one or two directions, place unusual strain patterns on the lifting equipment. In one exemplary condition, a cable used to lift and lower a tire may be subjected to lateral or swinging loading while lifting or lowering the tire, which may interfere and wear areas of the lift surrounding the cable, thus necessitating service, repair or replacement of various structures of the lift.

### SUMMARY

The disclosure provides a guide system for a cable in a compound motion tire lift, which guide system protects a casting of the lift from undue wear from contact with a lift cable. In one embodiment, the casting forms a radius for guiding the cable as the cable lifts and lowers the tire, as well as swings or angularly displaces relative to an opening or passage formed in the casting. Over time, the cable may wear the area of the casting surrounding the opening through which the cable extends, causing the casting to be replaced. Additionally, by rubbing against the casing, the cable becomes frayed, also needing replacement. The disclosure provides a guide that provides rolling surfaces that protect the casting and cable from damage. These rolling surfaces protect against swinging angles of the cable along any direction, and thus are arranged along four separate axes around the cable. In one embodiment, the cable guide can be offered as original equipment with a tire lift, and may additionally be configured as a retrofit or additional kit on existing lifts. The cable guide is uniquely suited for tire lift applications in which the hoisting or lifting of tires or carcasses imparts appreciable lateral or swinging loads on the cable while the cable is moving to raise or lower the tire.

One implementation relates to a guide assembly for a tire lift assembly that includes a mounting plate, a support structure extending from the mounting plate, and a first pair of rollers. The mounting plate has mounting holes to connect the mounting plate to a casting of the tire lift assembly. The support structure includes a first wall, a second wall, and a third wall defining an opening. The first wall is connected to and extends from the mounting plate. The second wall and the third wall are connected to and extend from the first wall. The second wall is opposite the third wall. The first pair of rollers are rotatably supported by the second wall and the third wall. The first pair of rollers are positioned on opposing sides of the opening defined by the first wall, the second wall, and the third wall. Each roller of the first pair of rollers rotates relative to the support structure when a cable of the tire lift assembly travelling through the opening contacts a roller of the first pair of rollers.

In some implementations, the guide assembly further includes a second pair of rollers rotatably supported by the first wall. The second pair of rollers are positioned non-parallel to the first pair of rollers on opposing sides of the opening defined by the first wall, the second wall, and the third wall. In some implementations, the first pair of rollers are perpendicular to the second pair of rollers. In some implementations, the first pair of rollers and the second pair of rollers surround the opening. In some implementations, the support structure further includes a fourth wall opposite the first wall. The fourth wall is connected to and extends from the second and third wall. The second pair of rollers are further rotatably supported by the fourth wall. In some implementations, the first pair of rollers are rotatably supported by fasteners extending through a set of holes formed in the second wall. In some implementations, the first pair of rollers are bushings. In some implementations, the support structure is U-shaped.

Another implementation relates to a tire lift assembly that includes a cable dispensing portion, a cable anchor portion, an expandable portion, a cable, and a guide assembly. The cable dispensing portion includes a casting forming an integral passage. The cable anchor portion is opposite the cable dispensing portion. The expandable portion is positioned between the cable anchor portion and the cable dispensing portion. The cable is anchored at the cable anchor portion and extends through the expandable portion and out through the integral passage of the casting of the cable dispensing portion. The guide assembly is connected to the casting of the cable dispensing portion and includes a mounting plate, a support structure extending from the mounting plate, and a first pair of rollers. The mounting plate is connected to the casting of the cable dispensing portion. The support structure includes a first wall, a second wall, and a third wall defining an opening. The first wall is connected to and extends from the mounting plate. The second wall and the third wall are connected to and extend from the first wall. The second wall is opposite the third wall. The first pair of rollers are rotatably supported by the second wall and the third wall. The first pair of rollers are positioned on opposing sides of the opening defined by the first wall, the second wall, and the third wall. Each roller of the first pair of rollers rotates relative to the support structure when the cable contacts a roller of the first pair of rollers.

In some implementations, the guide assembly further includes a second pair of rollers rotatably supported by the first wall. The second pair of rollers are positioned non-parallel to the first pair of rollers on opposing sides of the opening defined by the first wall, the second wall, and the third wall. In some implementations, the first pair of rollers are perpendicular to the second pair of rollers. In some implementations, the support structure further includes a fourth wall opposite the first wall. The fourth wall is connected to and extends from the second and third wall. The second pair of rollers are further rotatably supported by the fourth wall. In some implementations, the first pair of rollers are rotatably supported by fasteners extending through a set of holes formed in the second wall. In some implementations, the first pair of rollers are bushings. In some implementations, the expandable portion includes a piston. In some implementations, the cable travels axially through the integral passage.

Yet another implementation relates to a method for modifying a tire lift assembly. The method includes providing a tire lift assembly that includes a cable dispensing portion having a casting forming an integral passage and a cable extending through the integral passage of the casting of the cable dispensing portion. The method includes providing a guide assembly that includes a mounting plate, a support structure extending from the mounting plate, and a first pair of rollers. The support structure includes a first wall, a second wall, and a third wall defining an opening. The first wall is connected to and extends from the mounting plate. The second wall and the third wall are connected to and extend from the first wall. The second wall is opposite the third wall. The first pair of rollers are rotatably supported by the second wall and the third wall. The first pair of rollers are positioned on opposing sides of the opening defined by the first wall, the second wall, and the third wall. Each roller of the first pair of rollers rotates relative to the support structure when the cable contacts a roller of the first pair of rollers. The method further includes feeding an end of the cable through the opening defined by the first wall, the second wall, and the third wall. The method further includes connecting the mounting plate of the guide assembly to the casting of the cable dispensing portion of the tire lift assembly.

In some implementations, the guide assembly further includes a second pair of rollers rotatably supported by the first wall. The second pair of rollers are positioned non-parallel to the first pair of rollers on opposing sides of the opening defined by the first wall, the second wall, and the third wall. In some implementations, the first pair of rollers are perpendicular to the second pair of rollers. In some implementations, the support structure further includes a fourth wall opposite the first wall. The fourth wall is connected to and extends from the second and third wall. The second pair of rollers are further rotatably supported by the fourth wall.

### BRIEF DESCRIPTION OF THE DRAWINGS

FIG. 1 is a tire lift assembly in accordance with the disclosure;

FIG. 2 is a top view of the tire lift assembly of FIG. 1;

FIG. 3 is an end view of the tire lift assembly of FIG. 1;

FIG. 4 is a section view through a lift roller of the tire lift assembly of FIG. 1;

FIG. 5 is a bottom view of a guide assembly for the tire lift assembly of FIG. 1;

FIG. 6 is a side view of the guide assembly of FIG. 5 with the pairs of rollers removed;

FIG. 7 is a back view of the guide assembly of FIG. 5 with the pairs of rollers removed;

FIG. 8 is a back view of the guide assembly of FIG. 5;

FIG. 9 is a side view of the guide assembly of FIG. 5; and

FIG. 10 is a partial, enlarged assembly view of the guide assembly of FIG. 5 installed on the tire lift casting of the tire lift assembly of FIG. 1.

### DETAILED DESCRIPTION

In the description that follows, structures and features that are the same or similar as shown in the various views of the drawings are denoted by the same reference numerals throughout the several views for consistency and simplicity, but it should be appreciated that the various structures or features may differ that those shown.

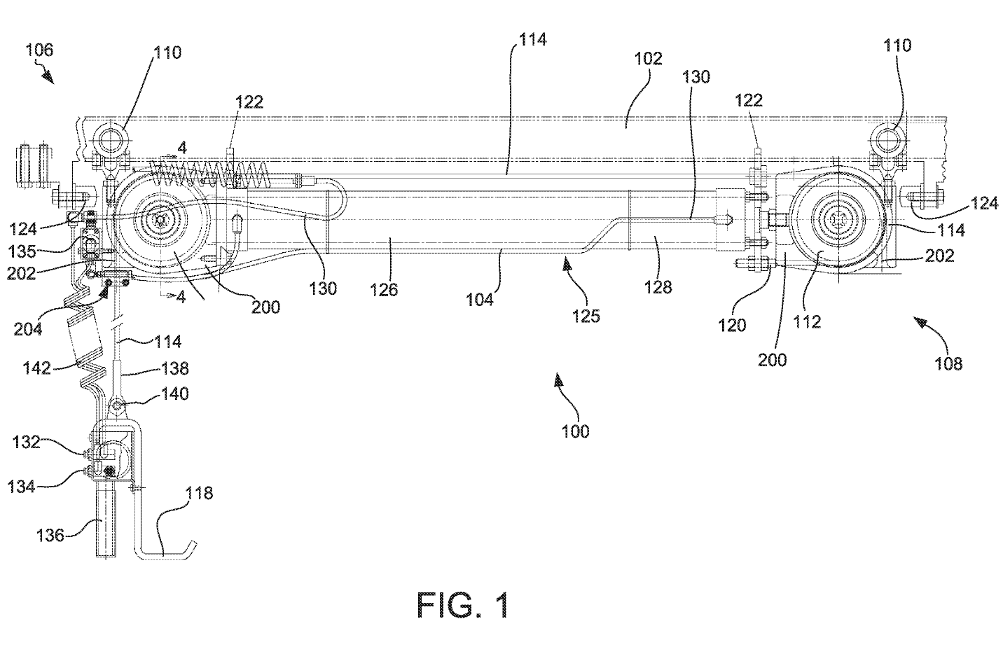

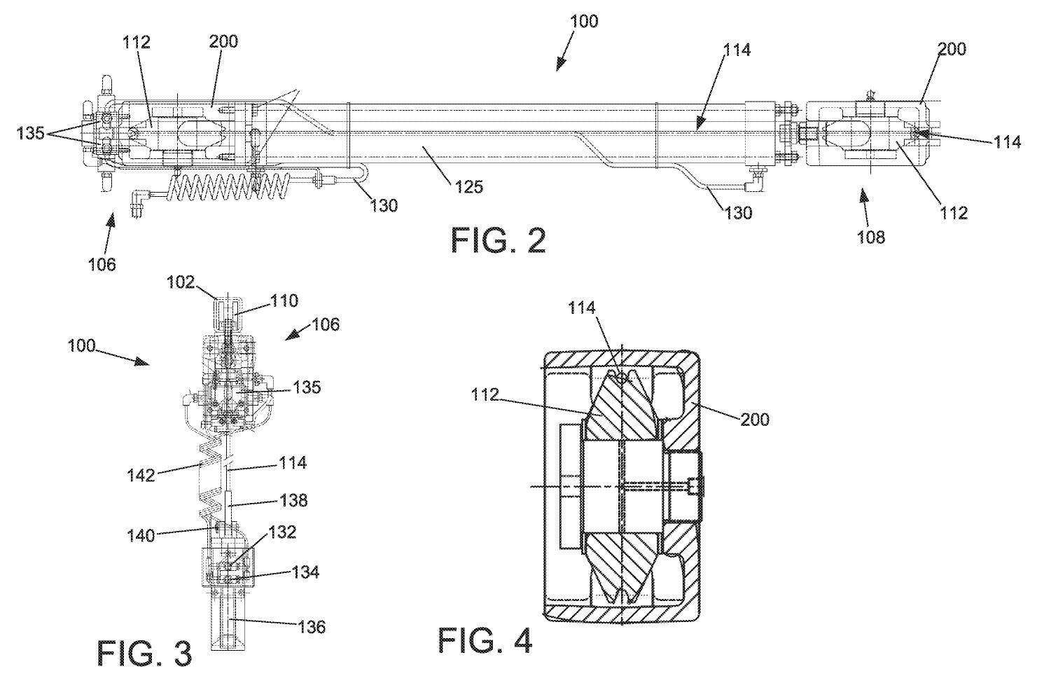

A tire lift assembly 100 is shown in FIGS. 1-4. In the illustrated embodiment, the tire lift assembly 100 is configured as an overhead lift or gantry that is mounted on a ceiling joist, which is generally denoted as joist 102. The tire lift assembly 100 has a generally elongate shape that includes an expandable central portion 104, which is flanked by a cable dispensing portion 106 at one end and a cable anchoring portion 108 at another end. Each end 106 and 108 is slidably connected with the joist through rollers or roller bearings 110 but other arrangements can be used. Each end 106 and 108 further includes a pulley 112. The pulleys 112 guide a cable 114 along the length of the tire lift assembly 100 and down the cable dispensing portion 106.

During operation, extension or retraction of the expandable central portion 104 causes a lifting or lowering of a hook 118 connected on a free end of the cable 114. An opposite end of the cable 114 is anchored at a mount 120 disposed on the cable anchoring portion 108. As the lift is moving along the joist 102, which can be embodied as a C-beam (see FIG. 4), brackets 122 guide the two ends 106 and 108 along the joist 102 as the two ends 106 and 108 move towards or away from one another. To limit the travel of the lift 100 along the joist 102, bumpers 124 are disposed on either end of the lift 100 and mounted to the joist 102. The bumpers 124, which may have resilient properties, prevent excessive travel along the joist 102 and help retain the roller bearings 110 engaged with the joist 102.

In the particular construction of the lift 100 shown here, the expandable central portion 104 is embodied as a piston 125, which may operate under pneumatic power, but other types of power may be used such as hydraulic, electrical or mechanical. The piston 125 includes a first segment 126, which forms a piston bore (not shown) therein, and a second segment 128, which includes a piston plunger (not shown) that is slidably and sealably disposed within the piston bore such that two sealed chambers are formed within the bore on either side of the plunger, in the known fashion. Fluid lines 130, which are in fluid communication with the two sealed chambers, one on each side, provide fluid under pressure causing the plunger to move within the bore, as is known, which in turn causes the expandable central portion 104 of the lift 100 to move and lift of lower the hook 118 via the cable, as previously discussed. As shown, control buttons 132 and 134 are mounted on an operator control handle 136 that is associated with the hook 118 and dangles off the free end of the cable 114 through a finial 138 and pivot pin 140. The control buttons 132 and 134 associated with the handle 136 activate fluid valves 135 (FIG. 1) via flexible lines 142 to provide pressurized fluid to the lines 130.

In the construction for the lift 100 described herein, either end of the lift 100 can be configured as the cable dispensing end 106 or the cable anchoring end 108. As shown, either end includes a casting 200 that forms an integral passage 202 extending tangentially with respect to the pulley 112, through which passage the cable 114 extends. On the cable dispensing end 106, during operation, the extending and retracting of the piston 125 may impart lateral moments on the cable 114. Moreover, the pin 140 and a weight such as a tire handing on the hook 118 may provide a swinging motion to the cable 114 as the cable 114 travels axially through the integral passage 202, thus causing cable contact and rubbing with the material of the casting 200, which leads to undue wear.

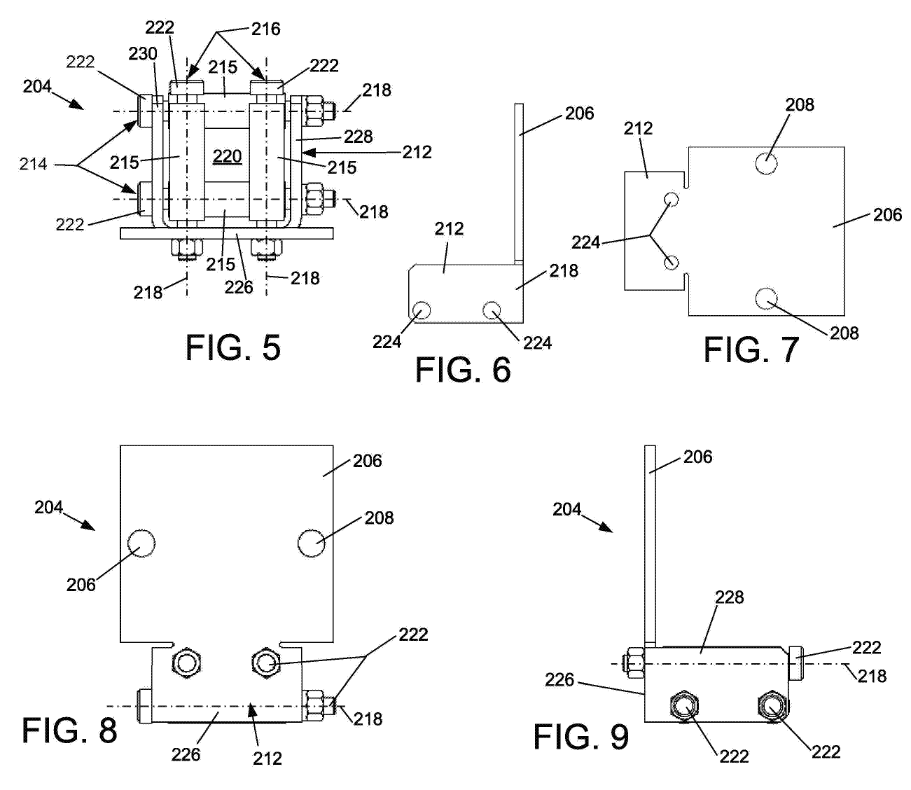

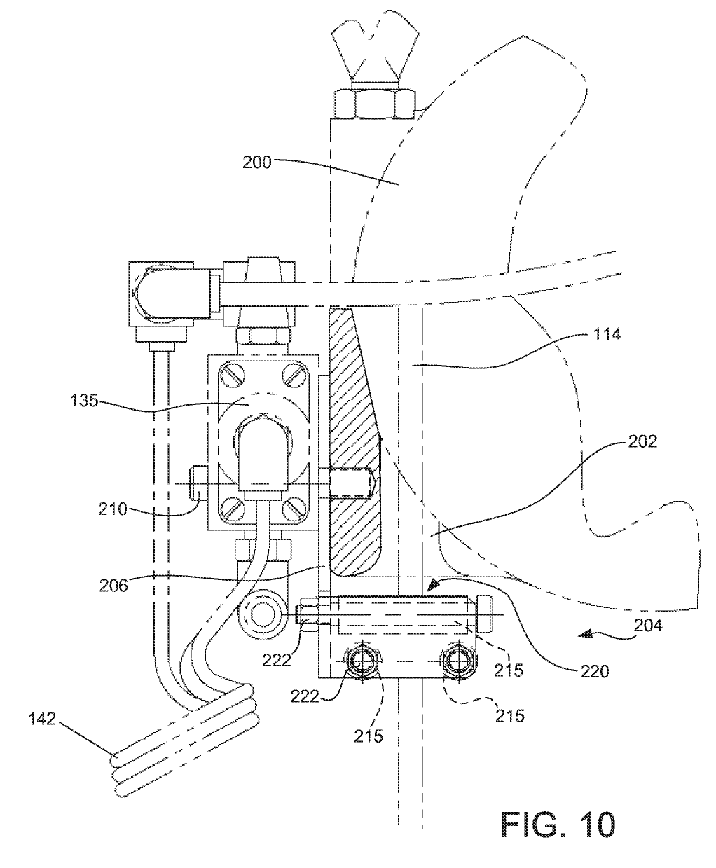

To minimize or eliminate such wear on the cable dispensing end 106 of the lift 100, a guide assembly 204 is provided. The guide assembly 204, and its various components, are shown in FIGS. 5-9. In reference to these figures, the guide assembly 204 includes a mounting plate 206 having mounting holes 208 formed therein. Fasteners 210 (FIG. 10) can extend through the mounting holes 208 and engage corresponding threaded openings formed in the casting 200 to mount the guide assembly 204 onto the cable dispensing end 106 of the lift 100.

The guide assembly 204 further includes a support structure 212 that rotatably supports a first pair 214 of elongate rollers 215 and a second pair 216 of elongate rollers 215. Each roller 215 includes a centerline 218, which also coincides with the respective roller's rotational axis, such that two parallel axes 218 are defined by the rollers 215 of the first pair 214, and two parallel axes 218 are defined by the rollers 215 of the second pair 216. In the illustrated embodiment, the axes 218 of the rollers 215 in the first pair 214 are perpendicular to the axes 218 of the rollers 215 in the second pair 216, but any other angle can be used. For example, instead of the four rollers 215 forming a rectangle surrounding an opening 220, when viewed from the top as shown in FIG. 5, the rollers can alternatively form a diamond, a triangle, etc. Moreover, although four rollers 215 are shown, fewer or more rollers can be used. In one contemplated embodiment, six or eight rollers are arranged in a closed pattern surrounding the opening 220, while in a different embodiment, three rollers are arranged in a triangular configuration around the opening 220. Any number or arrangement of rollers can be used to surround the opening, provided that rolling surfaces are disposed around the opening 220.

In the embodiment shown, the rollers 215 are mounted onto the support structure 212 by fasteners 222 that extend through and engage holes 224 formed in the support structure 212. The support structure 212 is generally U- or C-shaped and includes a first wall 226, which is connected to the mounting plate 206, a second wall 228, which is connected to the first wall 226 and extends away therefrom in a direction of the opening 220, and a third wall 230, which is connected to the first wall 226 opposite the second wall 228 and also extends away from the first wall 226 in the direction of the opening. A fourth wall (not shown) that is connected to the second and third walls 228 and 230 may also be used. The first, second and third walls 226, 228 and 230 in the illustrated embodiment surround the opening 220 such that, when the rollers 215 are mounted to the walls 226, 228 and 230, the rollers will surround the opening.

An enlarged detail view of the guide assembly 204 connected to a casting 200 of a lift 100 (FIG. 1) is shown in FIG. 10. In this embodiment, two fasteners 210 (one visible) are used to connect the mounting plate 206 to the casting 200, each of which is a ¼-20 bolt. The guide assembly 204 includes two socket head screws that are 6 mm diameter×45 mm long, and two screw shoulder socket head 6 mm diameter×40 mm long screws, for a total of four screws that make up the fasteners 222 along with four 5 mm hex lock nuts. The rollers 215 are made from four drill bushing steel Type P 0.25″ID×13/32″0D×1.38″ long bushings. The two single support rollers 215 by fasteners 222 include two lock external tooth 6M washers. The mounting plate 206 and the material of the first 226, second 228, third 230 and fourth walls is made of cut and shaped sheet metal made from steel and having a nominal thickness of 0.12 in. stock.

The guide assembly 204 is mounted such that the cable 114 passes through the opening 220 (FIG. 5). In this way, any deflection of the cable 114, e.g. by swinging, during service will cause contact to occur between the cable 114 and rollers 215 rather than with the material of the casting 200. The rolling capability of the rollers 215 avoids sliding contact with the cable 114, which eliminates cable fraying and wear in the casting 200. Advantageously, the guide assembly 204 may be installed in already worn castings 200 because further contact of the cable 114 with the casting 200 will be precluded when the guide assembly 204 is used.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A guide assembly for a tire lift assembly, the guide assembly comprising:
a mounting plate having mounting holes to connect the mounting plate to a casting of the tire lift assembly;
a support structure extending from the mounting plate, the support structure comprising a first wall, a second wall, and a third wall defining an opening, the first wall connected to and extending from the mounting plate, the second wall and the third wall connected to and extending from the first wall, the second wall opposite the third wall; and
a first pair of rollers rotatably supported by the second wall and the third wall, the first pair of rollers positioned on opposing sides of the opening defined by the first wall, the second wall, and the third wall;
wherein each roller of the first pair of rollers rotates relative to the support structure when a cable of the tire lift assembly travelling through the opening contacts a roller of the first pair of rollers.

2. The guide assembly of claim 1, further comprising:
a second pair of rollers rotatably supported by the first wall, the second pair of rollers positioned non-parallel to the first pair of rollers on opposing sides of the opening defined by the first wall, the second wall, and the third wall.

3. The guide assembly of claim 2, wherein the first pair of rollers are perpendicular to the second pair of rollers.

4. The guide assembly of claim 2, wherein the first pair of rollers and the second pair of rollers surround the opening.

5. The guide assembly of claim 2, wherein the support structure further comprises a fourth wall opposite the first wall, the fourth wall connected to and extending from the second and third wall, wherein the second pair of rollers are further rotatably supported by the fourth wall.

6. The guide assembly of claim 1, wherein the first pair of rollers are rotatably supported by fasteners extending through a set of holes formed in the second wall.

7. The guide assembly of claim 1, wherein the first pair of rollers comprise bushings.

8. The guide assembly of claim 1, wherein the support structure is U-shaped.

9. A tire lift assembly comprising:
a cable dispensing portion comprising a casting forming an integral passage;
a cable anchor portion opposite the cable dispensing portion;
an expandable portion positioned between the cable anchor portion and the cable dispensing portion;
a cable anchored at the cable anchor portion and extending through the expandable portion and out through the integral passage of the casting of the cable dispensing portion; and
a guide assembly connected to the casting of the cable dispensing portion, the guide assembly comprising:
a mounting plate connected to the casting of the cable dispensing portion;
a support structure extending from the mounting plate, the support structure comprising a first wall, a second wall, and a third wall defining an opening, the first wall connected to and extending from the mounting plate, the second wall and the third wall connected to and extending from the first wall, the second wall opposite the third wall; and
a first pair of rollers rotatably supported by the second wall and the third wall, the first pair of rollers positioned on opposing sides of the opening defined by the first wall, the second wall, and the third wall;
wherein each roller of the first pair of rollers rotates relative to the support structure when the cable contacts a roller of the first pair of rollers.

10. The tire lift assembly of claim 9, wherein the guide assembly further comprises:
a second pair of rollers rotatably supported by the first wall, the second pair of rollers positioned non-parallel to the first pair of rollers on opposing sides of the opening defined by the first wall, the second wall, and the third wall.

11. The tire lift assembly of claim 10, wherein the first pair of rollers are perpendicular to the second pair of rollers.

12. The tire lift assembly of claim 10, wherein the support structure further comprises a fourth wall opposite the first wall, the fourth wall connected to and extending from the second and third wall, wherein the second pair of rollers are further rotatably supported by the fourth wall.

13. The tire lift assembly of claim 9, wherein the first pair of rollers are rotatably supported by fasteners extending through a set of holes formed in the second wall.

14. The tire lift assembly of claim 9, wherein the first pair of rollers comprise bushings.

15. The tire lift assembly of claim 9, wherein the expandable portion comprises a piston.

16. The tire lift assembly of claim 9, wherein the cable travels axially through the integral passage.

17. A method for modifying a tire lift assembly, the method comprising:
providing a tire lift assembly comprising:
a cable dispensing portion comprising a casting forming an integral passage; and
a cable extending through the integral passage of the casting of the cable dispensing portion;
providing a guide assembly comprising:
a mounting plate;
a support structure extending from the mounting plate, the support structure comprising a first wall, a second wall, and a third wall defining an opening, the first wall connected to and extending from the mounting plate, the second wall and the third wall connected to and extending from the first wall, the second wall opposite the third wall; and
a first pair of rollers rotatably supported by the second wall and the third wall, the first pair of rollers positioned on opposing sides of the opening defined by the first wall, the second wall, and the third wall;
wherein each roller of the first pair of rollers rotates relative to the support structure when the cable contacts a roller of the first pair of rollers;
feeding an end of the cable through the opening defined by the first wall, the second wall, and the third wall; and
connecting the mounting plate of the guide assembly to the casting of the cable dispensing portion of the tire lift assembly.

18. The method of claim 17, wherein the guide assembly further comprises:
a second pair of rollers rotatably supported by the first wall, the second pair of rollers positioned non-parallel to the first pair of rollers on opposing sides of the opening defined by the first wall, the second wall, and the third wall.

19. The method of claim 18, wherein the first pair of rollers are perpendicular to the second pair of rollers.

20. The method of claim 18, wherein the support structure further comprises a fourth wall opposite the first wall, the fourth wall connected to and extending from the second and third wall, wherein the second pair of rollers are further rotatably supported by the fourth wall.
